(19) United States
(12) Patent Application Publication
(10) Pub. No.: US 2012/0242479 A1
(43) Pub. Date: Sep. 27, 2012

(54) Vehicle traffic lane change signaling device

(76) Inventors: Ohanes D. Ghazarian, Henderson, NV (US); William Lee Eaves, Victorville, CA (US)

(21) Appl. No.: 13/385,682

(22) Filed: Feb. 29, 2012

Related U.S. Application Data
(60) Provisional application No. 61/465,679, filed on Mar. 23, 2011.

(51) Int. Cl. B60Q 1/34

(52) U.S. Cl. 340/465

(57) ABSTRACT

An automatic vehicle left or right turn signaling device utilizes a vehicle mount traffic lane detection sensor(s), the vehicle mount traffic lane detection sensor(s) in response to detecting traffic lane presence near proximity of a vehicle, the vehicle signaling device automatically activates the vehicle left or right turn signal lights to warn other vehicle drivers that the particular vehicle moving towards near proximity of a next traffic lane. The vehicle signaling device may be connected to a GPS navigation device. The navigation device based on given route information provides signals to vehicle mount traffic signaling device to automatically flash the vehicle left or right turn signal lights based on received GPS navigation given instructions prior to or during the driver making a left or right lane change, making a left or right turn, or a U turn.

### BACKGROUND OF INVENTION

In the pass many different methods has been used in vehicles for the vehicle driver to signal other vehicles when a driver decides to make a traffic lane change, or make a left or right turn, by manually activating an electro/mechanical signaling device which flashes the vehicle left or right signal lights to indicate to other vehicle drivers that the driver of the vehicle will be making a traffic lane change, or the driver will be making a left or right turn, or may be exiting off the road. In the pass the vehicle signaling devices also were used to flash vehicle emergency lights to warn other vehicle drivers, when a particular vehicle having an emergency condition and the driver decides to pull off the road. Unfortunately the teachings found in prior art, the operation of the vehicles signal lights was relied on driver decision to manual control the operation of the vehicle left or right turn signal lights, which is known to the art that sometimes vehicle driver's may make traffic lane change or left or right turns without using or forgetting to use the vehicles signal lights.

It is primary objective of the present invention to utilize an improved vehicle signal light signaling device which automatically activates vehicle signal lights to warn other vehicle drivers if and when a vehicle driver changes the vehicle direction towards the next traffic lane, or change the vehicle direction towards making a left or right turn and forget to activate the vehicle's signal lights. Or the vehicle driver may become unaware and the vehicle driver may sway the vehicle position on the left or right side of traffic divider lane, or the driver may sway the vehicle near the traffic side lane, or the driver may desire to move the vehicle off the road.

It is another objective of the present invention that utilizes a vehicle GPS navigation device connected to the vehicle mount signaling device. The navigation device based on given route information provides signals to vehicle mount traffic signaling device to automatically flash the vehicle left or right signal lights prior or during the vehicle driver make a left or right turn based on received GPS navigation given signals to make a left or right traffic lane change, or a left or right turn, or a U turn, to minimize possibility of vehicle accident.

### SUMMARY OF THE INVENTION

The present invention utilizes a vehicle mount traffic lane detection sensor(s) mounted on a vehicle, the sensor(s) designed to detect traffic divider lane(s) or road side lane(s). The sensor(s) are connected to a vehicle mount signaling device which is connected to the vehicle signal lights.

The vehicle automatic signaling device processor in response to received signal(s) from the vehicle traffic lane detection sensor(s) that the vehicle position is in close proximity of at least one side of traffic divider lane, the vehicle signaling device automatically flash's the vehicle left or right turn signal lights to warn other vehicle drivers that the particular vehicle is in course off changing traffic lane, accordingly other vehicle(s) drivers take necessary safety measures. In addition the present vehicle automatic signaling device in response to received signals from the vehicle traffic lane detection sensor may automatically flash vehicle emergency signal lights, if and when the vehicle sways out of traffic side lane.

In a preferred embodiment of the present invention, a vehicle GPS navigation device may be connected to the vehicle mount signaling device. The vehicle automatic signaling device in response to received instruction from the vehicle GPS navigation device for a left or right turn, said vehicle signaling device automatically flash's said vehicle left or right signal lights at a set distance from a left or right turn, or a U tern, a traffic exist traffic point.

### BRIEF DESCRIPTION OF THE DRAWINGS

FIG. 1 Illustrates a vehicle equipped with traffic lane sensors, and the vehicle signal lights.

FIG. 2 Illustrates automatic vehicle signaling device, a GPS navigation device, and the vehicle signal lights.

FIG. 3 Illustrates automatic vehicle signaling device system block diagram.

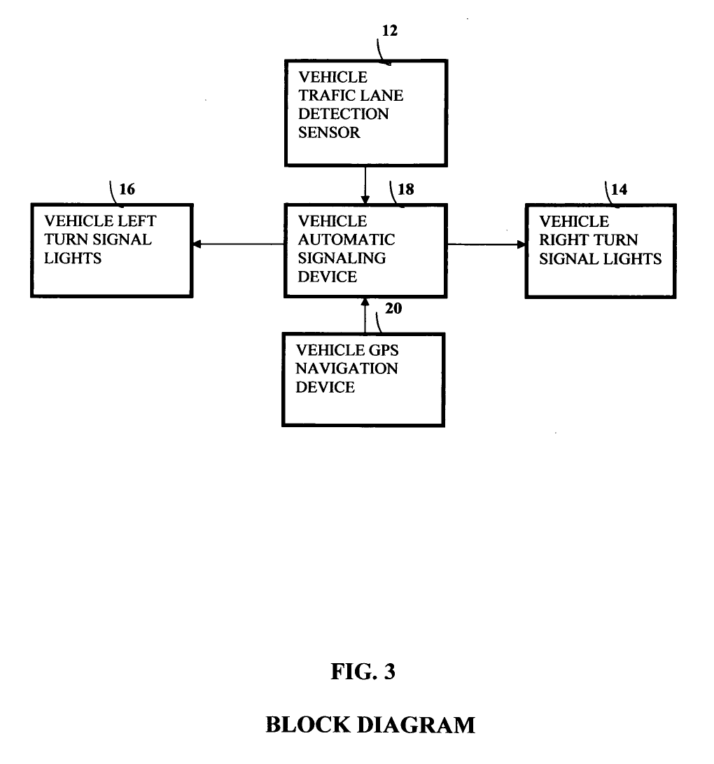

### DETAILED DESCRIPTION OF A PREFERRED EMBODIMENT OF THE INVENTION

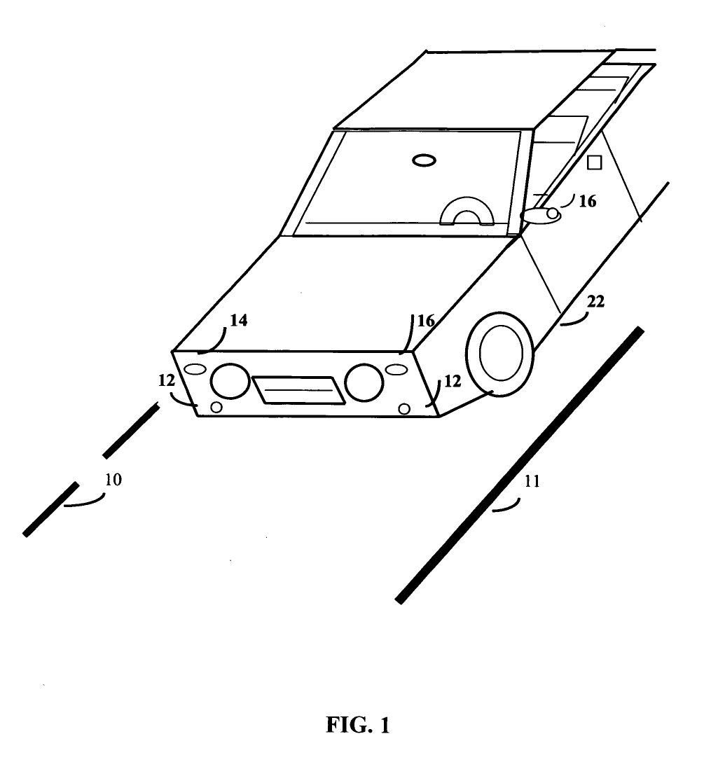

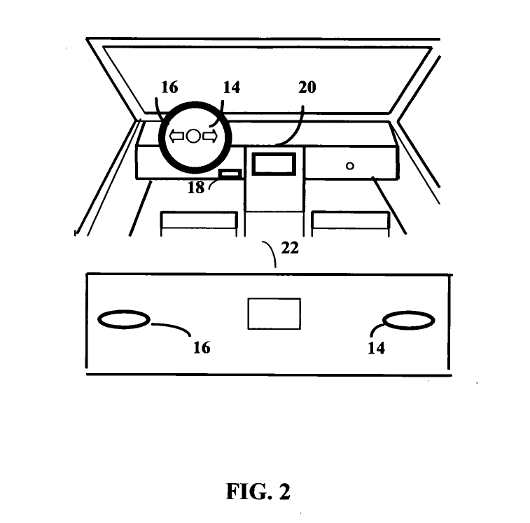

The present invention utilizes a FIG. 1 vehicle 22 traffic lane 10, 11 detection sensor(s) 12 mounted on a vehicle 22, the sensor(s) 12 designed to detect traffic divider lane(s) 10 or road side lane(s) 11. The sensor(s) 12 are connected to FIG. 2 a vehicle 22 mount automatic signaling device 18, which is connected to the vehicle signal lights 14, 16. The vehicle 22 automatic signaling device processor 18 in response to received signals from the vehicle traffic lane detection sensor(s)12, the vehicle being is in close proximity of at least one side of traffic divider lane 10, the vehicle automatic signaling device 18 automatically flash's the vehicle left or right turn signal lights 14, 16 to warn other vehicle drivers that the particular vehicle 22 is in course off changing traffic lane, accordingly other vehicle(s) (Not shown in drawing) drivers take necessary safety measures. In addition the present vehicle automatic signaling device 18 in response to received signals from the vehicle traffic lane 11 detection sensor(s) 12, may automatically flash vehicle emergency signal lights 14, 16. if and when the vehicle sways out of traffic side lane.

The vehicle 22 mount traffic lane sensor(s) 12 may be of visual sensor(s) such as camera, a night vision camera capable of capturing traffic lane images. The vehicle 22 sensor(s) 12 may be of optical sensors 12, or RF transponder readers capable of reading traffic divider lane mount 10, 11 RF transponders (Not shown on drawing). Or the vehicle 22 mount sensor(s) 12 may be off RF electromagnetic sensor(s) 12, or the vehicle 22 sensor(s) 12 may utilize other means to detect the presence of traffic divider lane near proximity of the vehicle 22.

In a preferred embodiment of the present invention, a vehicle 22 GPS navigation device 20 may be connected to the vehicle signaling device 18. The vehicle 22 signaling device 18 in response to received instruction from the vehicle GPS navigation device 20, the vehicle signaling device 18 automatically flash's the vehicle 22 left or right signal lights 14, 16 at a set distance from a left or right turn traffic point, a U turn point, or a traffic exit point.

Further the vehicle GPS navigation device 20 may of a portable carry on devise containing an RF transmitter, and the vehicle 22 signaling device may have an RF receiver or a transceiver which may be used to establish wireless communication with the vehicle 22 signaling device to flash the vehicle left or right or both signal lights 14, 16, based on wirelessly given signals from the portable GPS navigation device to the vehicle signaling device.

1- An automatic vehicle signaling device comprising;
a vehicle traffic divider lane detection sensor(s) mounted on a vehicle and connected to a vehicle mount automatic signaling device, said signaling device is connected to said vehicle signal lights,
said vehicle sensor(s) in response to detecting traffic divider lane presence a set distance from said vehicle, said sensor(s) transmits said traffic divider lane detected signal(s) to said vehicle automatic signaling device, said vehicle automatic signaling device upon receipt of said traffic lane presence detected signal(s), said automatic signaling device processor based on received traffic lane detection signal(s) indicative of said vehicle being too close to said traffic divider lane or said vehicle is on the next traffic lane, said vehicle signaling device automatically activates said vehicle at least left or right turn or both signal lights to warn other vehicle drivers said particular vehicle is moving towards next traffic lane, or pulling over said vehicle at least to one side of the road.

2- An automatic vehicle signaling device comprising;
a GPS navigation device connected to a vehicle automatic signaling device, said automatic signaling device is connected to said vehicle signal lights,
said navigation device based on given route information provides signals to vehicle mount signaling device to automatically flash said vehicle at least left or right turn or both signal lights based on received GPS navigation device given instructions signals for a left or right lane change, or makes a left or right turn, or a U turn, or make an exit, or when said vehicle driver pull's over said vehicle at least to one side of the road.

3- An automatic vehicle signaling device as claimed in claim 1, wherein said vehicle traffic divider lane sensor(s) may be of optical sensor(s), visual video sensor(s), RF sensor(s), or RF electromagnetic sensors, or other means of sensor(s) used to detect the presence of traffic divider lane or at least one side of road side lane.

4- An automatic vehicle signaling device as claimed in claim 2, wherein said vehicle GPS navigation device may of a portable devise containing an RF transmitter, and said vehicle signaling device may have an RF transceiver which is used to receive wireless signals from said portable GPS navigation device to flash said vehicle left or right or both signal lights.
